(19) United States
(12) Patent Application Publication
(10) Pub. No.: US 2013/0031063 A1
(43) Pub. Date: Jan. 31, 2013

(54) COMPRESSION OF DATA PARTITIONED INTO CLUSTERS

(71) Applicants: Nikolaos Freris, Kilchberg (CH); Michail Vlachos, Zurich (CH)

(72) Inventors: Nikolaos Freris, Kilchberg (CH); Michail Vlachos, Zurich (CH)

(73) Assignee: International Business Machines Corporation, Armonk, NY (US)

(21) Appl. No.: 13/552,916

(22) Filed: Jul. 19, 2012

(30) Foreign Application Priority Data
Jul. 26, 2011 (EP) 11175362.0

(51) Int. Cl. G06F 7/00; G06F 17/30

(52) U.S. Cl. 707/693; 707/E17.002

(57) ABSTRACT

The invention notably relates to a computer-implemented method for compressing data. The data is partitioned into clusters of pieces of data resulting from K-means clustering. Each cluster has a centroid. The method comprises applying (S10) a compression scheme to the data. The compression scheme preserves the centroid of each cluster and reduces the variance of each cluster. The method also comprises rescaling (S20) the data by moving the pieces of data towards the centroid of their cluster. Such a method improves the compression of data partitioned into clusters.

### FIELD OF THE INVENTION

The invention relates to the field of computer science, and more specifically, to a computer-implemented method, a program and a data storage medium for compressing and/or decompressing data partitioned into clusters.

### BACKGROUND

Data clustering is an important operation in data mining and machine learning. Among the different clustering techniques, the K-means algorithm is a widely known and used algorithm. The K-means algorithm is widely supported due to its generality and high-applicability in a variety of settings and applications, ranging from image segmentation (as discussed by M. Luo, Y.-F. Ma, and H.-J. Zhang in their article entitled “A Spatial Constrained K-Means Approach to Image Segmentation” in IEEE Int. International Conference on Information Communications and Signal Processing, pages 738-742, 2003) to co-clustering (as discussed by A. Anagnostopoulos, A. Dasgupta, and R. Kumar in their article entitled “Approximation algorithms for co-clustering” in Proc. of PODS, pages 201-210, 2008) or even analysis of biological datasets (as discussed by S. Das and S. Idicula in their article entitled “K-Means greedy search hybrid algorithm for biclustering gene expression data” in Advances in Exp. Medicine and Biology 2010, pages 181-188, 2010). Recently, many alternative clustering algorithms with desirable stability properties have been derived (e.g. spectral methods, as discussed by F. Bach and M. Jordan in their article entitled “Learning spectral clustering.” in Proc. of NIPS, 2004). However, K-means is a widely prevalent approach due to its simplicity of implementation, amenity to parallelization and execution speed. Notably for applications where speed is of essence, or when interested in performing an initial pre-clustering for data analysis, K-means is still the algorithm of choice.

Like most clustering algorithms, the K-means algorithm remains costly in terms of computation. Compounded with the fact of exponentially increasing dataset sizes, clustering large datasets with K-means is becoming an increasingly challenging task. Some approaches investigate scaling-up the K-means algorithm, such as the one discussed by J. Lin, M. Vlachos, E. J. Keogh, and D. Gunopulos in their article entitled “Iterative Incremental Clustering of Time Series” in Proc. of EDBT, pages 106-122, 2004 and the one discussed by P. S. Bradley, U. M. Fayyad, and C. Reina in their article entitled “Scaling Clustering Algorithms to Large Databases” in Proc. of SIGKDD, pages 9-15, 1998. These approaches examine the problem from a dimensionality reduction or from a sampling perspective. However, these approaches do not make any assertions regarding cluster preservation. Recently, there has been a surge of interest in K-means parallel implementations for cloud computing using the Hadoop paradigm (as discussed by S. Caron et al. in their paper entitled “Cloudster: K-means algorithm for cloud computing”, 2009, and also by X. Wang in the technical report entitled “Clustering in the Cloud: Clustering Algorithms to Hadoop Map/Reduce Framework”, Texas State University, 2010) or using the MapReduce paradigm (as discussed by W. Zhao, H. Ma, and Q. He in their article entitled “Parallel K-Means Clustering Based on MapReduce” in Proc. Of International Conference on Cloud Computing, pages 674-679, 2009). However, none of these works consider data compression.

Also of concern in the field of data mining is the question of privacy and data hiding. Privacy preserving variations for K-means may consider the scenario when data are segregated either horizontally (as discussed by G. Jagannathan and R. N. Wright in their article entitled “Privacy-preserving distributed k-means clustering over arbitrarily partitioned data” in Proc. of SIGKDD, pages 593-599, 2005) or vertically (as discussed by J. Vaidya and C. Clifton in their article entitled “Privacy-preserving K-means clustering over vertically partitioned data” in Proc. of SIGKDD, pages 206-215, 2003). These approaches require that the data are separated and do not apply well to the case where the data are distributed as a whole. Also known is the work of R. Parameswaran and D. Blough in their article entitled “A Robust Data Obfuscation Approach for Privacy Preservation of Clustered Data” in Workshop on Privacy and Security Aspects of Data Mining, pages 18-25, 2005. In this article, clustering preservation techniques are presented through Nearest Neighbor (NN) data substitution. Also known is the work presented by S. R. M. Oliveira and O. R. Zaïane in their article entitled “Privacy Preservation When Sharing Data For Clustering” In Intl. Workshop on Secure Data Management in a Connected World, 2004. They propose rotation-based transformations that retain the clustering outcome by changing the object values while maintaining the pairwise object distances, and hence the clustering result. This approach is not entirely satisfactory regarding the storage requirements with the guaranteed preservation, regarding the distortion of the original data structure and regarding the grain of control on the privacy-storage tradeoff.

Also of matter in the field of data mining is the quality of data reconstruction. In this area, various simplification techniques exist, such as the one presented by J. Bagnall, C. A. Ratanamahatana, E. J. Keogh, S. Lonardi, and G. J. Janacek in their paper entitled “A Bit Level Representation for Time Series Data Mining with Shape Based Similarity”, in Data Mining Knowledge Discovery 13(1), pages 11-40, 2006 who propose a binary clipping method where data are converted into 0 and 1 if they lie above or below the mean value baseline. This representation has been applied for speeding up the execution of the K-means algorithm but fails to accurately preserve the data shapes. Relevant is also the work presented by J. Aβfalg, H.-P. Kriegel, P. Kröger, P. Kunath, A. Pryakhin, and M. Renz. in their article entitled “TTime: Threshold-Based Data Mining on Time Series”, in Proc. of ICDE, pages 1620-1623, 2008, which introduces a threshold-based representation for querying and indexing time series data. Worth of mentioning is also the discussion by V. Megalooikonomou, G. Li, and Q. Wang in their article entitled “A dimensionality reduction technique for efficient similarity analysis of time series databases” in Proc. of CIKM, pages 160-161, 2004, where the authors present a piecewise vector-quantization approximation for time series data which accurately preserves the shape of the original sequences. However, none of these approaches are inherently designed for providing guarantees on preserving the clustering outcome.

In the article by D. Turaga, M. Vlachos, and O. Verscheure entitled “On K-Means Cluster Preservation Using Quantization Schemes”, in IEEE International Conference on Data Mining (ICDM), pages 533-542, 2009, the authors propose using 1-bit Moment Preserving Quantization (MPQ) per cluster and dimension, and showed experimentally how this affects cluster preservation. Using this scheme, they were able to achieve a cluster preservation ratio of up to 80%. However, 100% cluster preservation for all instances is not guaranteed and the data is not hidden.

There is thus an urge for an improved solution for compressing and/or decompressing data partitioned into clusters.

### BRIEF SUMMARY OF THE INVENTION

According to one aspect, the invention is embodied as a computer-implemented method for compressing data. The data is partitioned into clusters of pieces of data, resulting from K-means clustering. Each cluster has a centroid. The method comprises applying a compression scheme to the data. The compression scheme preserves the centroid of each cluster and reduces the variance of each cluster. The method also comprises rescaling the data by moving the pieces of data towards the centroid of their cluster.

According to another aspect, the invention is embodied as a computer-implemented method for decompressing data. The compressed data is partitioned into clusters of pieces of data resulting from K-means clustering. Each cluster has a centroid. The method comprises rescaling the data by moving the pieces of data away from the centroid of their cluster.

According to another aspect, the invention is embodied as a computer program comprising instructions for performing the compression and/or decompression method.

According to another aspect, the invention is embodied as a computer readable storage medium having recorded thereon the computer program.

In the remainder of the description, the expressions “the compression method” and “the method” both designate the method for compressing data. The expression “decompression method” designates the method for decompressing data. The data to be decompressed by the decompression method may typically be data previously compressed by the compression method, although the decompression method may indifferently include or exclude that previous compression. The decompression method may thus be for retrieving data having gone through the compression method.

The method is for compressing data, and thus, through applying a compression scheme to the data, the method reduces the space taken by the data on the memory of a computer that executes the method. The method thereby improves the use of the computer, from a hardware point of view.

The data may be any type of data. Notably, the data may include any of the following types of high-dimensional data: spatiotemporal sequences, database records and time-series. The time-series might represent web trends, stock prices, medical measurements, sensor measurements etc. In summary, the method can handle any set of high-dimensional objects whether they contain numerical data, or categorical or combination. The method thus improves data-mining in the fields where such types of data are used.

At the same time, the method provides guarantees for undistorted clustering results when operating on the compressed data. Precisely, the step of rescaling can assure that the clustering structure is maintained on the compressed data when executing the step of applying the compression scheme, and the fact that the compression scheme preserves the centroids ensures that the clusters will have the same centroids after applying the compression scheme. The compression scheme may indeed modify the data by moving the pieces of data. This could lead to a loss of the clustering structure. For example, after applying the compression scheme, one piece of data may be assigned to a cluster different from the one to which that piece of data was originally assigned (if the clustering were to be performed again). This can happen for example when such piece of data is at the boundary of its original cluster and such boundary is near a neighboring cluster. By being moved (by the compression scheme), the piece of data may be displaced on the other side of such boundary and “enter” the neighboring cluster. The step of rescaling enhances the separation between the clusters. Thus, performing a K-means clustering would lead to the same structure (with the same assignments of the pieces of data to a respective cluster) whether the clustering is performed before or after the method. The method more particularly guarantees K-means cluster preservation for all instances.

The proposed method also enables encoding the original dataset via data compression followed by a lossless (invertible) data transformation based on cluster contraction. Based on the contraction level, the method enables multiple layers of anonymization. Indeed, the step of rescaling “hides” the original data.

By providing a tunable compression scheme along with a revertible data anonymization transformation, the method may preserve many of the underlying structural properties of the original data, so that the compressed data can be used for a variety of mining and visualization applications besides the intended focus on clustering. Possibly using multibit quantization schemes, the method can explicitly trade-off storage efficiency for shape preservation while always assuring cluster preservation.

### BRIEF DESCRIPTION OF THE DRAWINGS

A system and a process embodying the invention will now be described, by way of non-limiting example, and in reference to the accompanying drawings, where:

FIG. 1 represents an example of the compression method;

FIGS. 2 and 3 represent examples of MMSE quantization;

FIGS. 4 and 5 represent examples of the rescaling;

FIGS. 6-8 illustrate the separation between clusters; and

FIG. 9 shows test results; and

FIG. 10 shows an example of a computer system.

### DETAILED DESCRIPTION OF THE EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium/media (i.e., data storage medium/media) having computer readable program code recorded thereon.

Any combination of one or more computer readable medium/media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium, i.e., data storage medium, may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the likes and conventional procedural programming languages, such as the “C” programming language or similar programming languages. The program code may be executed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 1 shows a flowchart of an example of the compression method.

The method of the example first comprises performing (S5) a K-means clustering of the data. The data comprises pieces of data partitioned into K-means clusters. This implies that a distance may be defined between the pieces of data (i.e., the elements constituting the data) and that a mean may be computed between a set of the pieces of data. Indeed, the widely known K-means clustering partitions (i.e., divides) the data into K groups (or clusters), wherein K is a predetermined fixed natural number, so as to minimize the sum of intra-cluster variances. This may be efficiently performed for example using Lloyd's algorithm and/or Kmeans++ algorithm. The mean of each cluster is called “centroid”. The data may typically be numeric and the pieces of data may typically be numbers, or, vectors (i.e., arrays of numbers). In the case of the example of FIG. 1, the method comprises prior to all a step of performing (S5) the K-means clustering of the data. This allows computation of the centroids and the assignments of the pieces of data to a respective centroid (which amounts to providing the clustering structure). However, the fact that the data are partitioned does not necessarily mean that the clustering is actually performed but only that the clustering structure is provided. Thus, instead of performing (S5) the K-means clustering of the data, the method could comprise directly providing centroids and assignments of the pieces of data to a respective centroid.

The method of the example then comprises applying (S10) a compression scheme to the data. A compression scheme is any process that reduces the size taken by the data on the memory of the hardware running the method. The compression scheme of the method preserves the centroid of each cluster and reduces the variance of each cluster (here, the term “reduce” means that the variance after quantization is equal to or lower than the variance before quantization). In the case of the example of FIG. 1, the compression scheme includes a quantization (i.e., a mapping from the set consisting of the pieces of data to a smaller set of values, such as rounding values to some unit). In the case of the example, the compression scheme is a MMSE (Minimum Mean Square Error) quantization of the data.

The method of the example also comprises rescaling (S21, S22) the data, i.e., moving the pieces of data towards the centroid of their cluster. Because the pieces of data of a cluster are moved towards the centroid of the cluster, the method enhances the separation between the clusters. The clustering structure is thus more likely to be preserved. Because the compression scheme preserves the centroid of each cluster, the centroids remain the same in the end of the method. Thanks to the data being moved, it may be hidden and not directly exploitable, thereby ensuring privacy.

In the case of the example, the rescaling (S21, S22) is performed after applying (S10) the compression scheme. However, the compression scheme (S10) may alternatively be performed after the rescaling (S21, S22). In the example, the rescaling (S21, S22) is subject to a test (S15) of whether the clusters are well-separated or not. The rescaling (S21, S22) occurs if the test is negative, whereas the method ends if the test is positive. The clusters are said to be “well-separated” when the K-means clustering of the data would lead to the same clustering if performed on the original (i.e., raw) data or on the compressed data (i.e., the data after applying (S10) the compression scheme). The test (S15), which is optional, allows not to perform the rescaling (S21, S22) when not necessary and thus optimizes the method.

For each cluster, the MMSE quantization maps the pieces of data of the cluster to a smaller set of quantizers. The number of scalar quantizers used is fixed and equals the dimension of the data, i.e., each dimension is separately quantized by a scalar quantizer. The number of quantization levels depends on the contemplated compression rate. The values of the scalar quantizers are determined so as to minimize the sum of mean square errors (i.e., the square distance between the values of the pieces of data of cluster to the quantization level to which they are mapped). Such a quantization can be performed simply and offers a good trade-off between the compression rate and the preservation of quality of the data. Notably, such a quantization minimizes the mean square error due to quantization thus incurring minimal distortion to the original data. The MMSE quantization also maintains the mean of the dataset, thus not distorting the cluster centroids. The MMSE quantization also reduces the cluster variance and does not expand the span of the cluster in each direction, i.e., the maximal value of the quantized dataset constituting a cluster is smaller than the maximal value of the original one, and respectively the minimal value of the quantized dataset constituting a cluster is larger than the minimal value of the original one.

The MMSE quantization may be 1-bit or multi-bit, respectively leading to a higher compression rate or higher quality preservation. A 1-bit MMSE compression may be used for each distinct dimension of the pieces of data, which are thus scalar. Alternatively, the method may apply a hierarchical multi-bit MMSE-based quantization, which can further increase the reconstruction accuracy by increasing the number of bits allocated for representing each multidimensional data point.

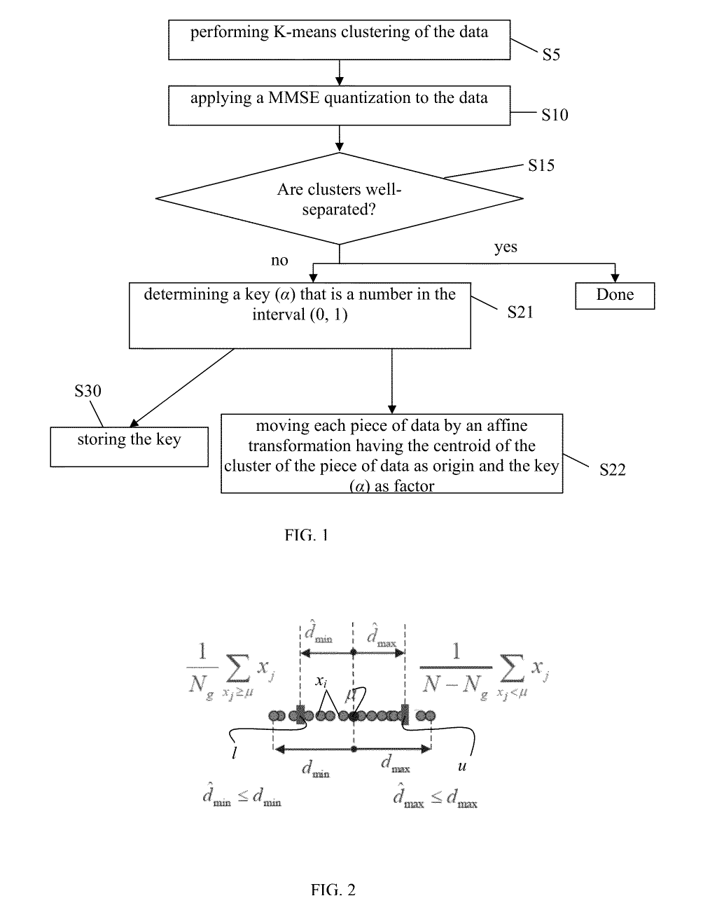

The 1-bit MMSE quantization is now described with an example, referring to FIG. 2. Given a dataset of scalar values, or points, for example the values of pieces of data of a cluster for a considered dimension, noted X={x}₁₌₁^{N} with sample mean μ (e.g. the value of the centroid of the cluster for the considered dimension) and sample variance σ², let l,u denote a lower and an upper quantization values (two quantization levels l and u are thus used). A point xᵢ is quantized to take the value l if it has value less than the mean μ, and is quantized to u if it has value greater than or equal to the mean value μ. The quantized point \hat{x}ᵢ thus verifies

$${\hat{x}}_{i} = \{ \begin{matrix}l , & {x}_{i} < μ \\ u , & {x}_{i} \geq μ .\end{matrix}$$

Selecting l,u in order to minimize the mean square error (MSE) yields that the optimal value for l (respectively u) is the mean value of all points with values less than (respectively greater than or equal to) the mean value μ which is set as the threshold for quantization. Formally, if the number of points with values greater than or equal to the mean μ is noted N_{g}, the method verifies

$$l = \frac{1}{N - {N}_{g}} {\sum }_{{x}_{i} < μ} {x}_{i}$$

$$u = \frac{1}{{N}_{g}} {\sum }_{{x}_{i} \geq μ} {x}_{i}$$

Let us consider for example a cluster comprised of the dataset {1,2,3,4,5,6,7,8,9,10}. The centroid is the mean value of the dataset and is μ=5.5 and the variance is σ²=8.25. The method determines the values above 5.5, i.e., the values {6,7,8,9,10} with corresponding mean 8, and the values below 5.5, i.e., the values {1,2,3,4,5} with corresponding mean 3. Therefore, the application of a 1-bit MMSE quantization leads to a quantized dataset equal to {3,3,3,3,3,8,8,8,8,8}. It is noted that:

i) The mean of the quantized dataset is \hat{μ}=5.5 equal to the mean of the original one.

ii) The variance of the quantized dataset is equal \hat{σ}=6.25 which is smaller than that of the original one.

iii) the maximum of the quantized dataset is 8, which is smaller than the maximum of the original one i.e., 10, and the minimum of the quantized dataset is 3, which is larger than the minimum of the original one i.e., 1. This means that the extent of the dataset “shrinks” post-quantization.

iv) this type of quantization is called “1-bit” because, basically, once u and l are determined and stored, only one bit is used per (dimension of a) piece of data, 0 and 1, or alternatively 1 or 0, in case the piece of data is to be quantized respectively to u or l.

The multi-bit MMSE quantization is now described. Multi-bit quantization can increase the fidelity in representing data, since the distortion due to quantization decreases as the number of bits allocated for representing each multidimensional data point increases.

We consider a multi-bit extension of the 1-bit MMSE quantizer that can further provide better reconstruction of the original objects. This may be useful for tasks other than clustering, such as when one is interested in accurate data visualization. Let Q=2^{q} be the number of quantization levels, q≧1 being the number of bits needed for representation of each dimension of the pieces of data. The proposed quantization scheme amounts to sequentially breaking the data into Q sub-datasets by recursively constructing a hierarchical binary tree with at most Q leaves (and q stages). The root represents the entire dataset to be quantized, and corresponds to level 1. Then, at level (i.e., depth) i<q, each node represents a sub-dataset. For each such node, if it contains two or more datapoints (i.e., a dimension of two or more pieces of data), the method may calculate the mean of the corresponding sub-dataset and further divide it into two subsets, one containing the values greater than or equal to the mean and the other one the values lower than the mean. The mean of the sub-dataset is set as a threshold value. Else, i.e., when the node represents a singleton sub-dataset, the method may set the singleton as a leaf node and keep the data-point value as it is. At the final stage (i=q), for each resulting sub-dataset n=1, . . . , Q, the method may perform a 1-bit MMSE quantization to quantize its values as described with reference to FIG. 2.

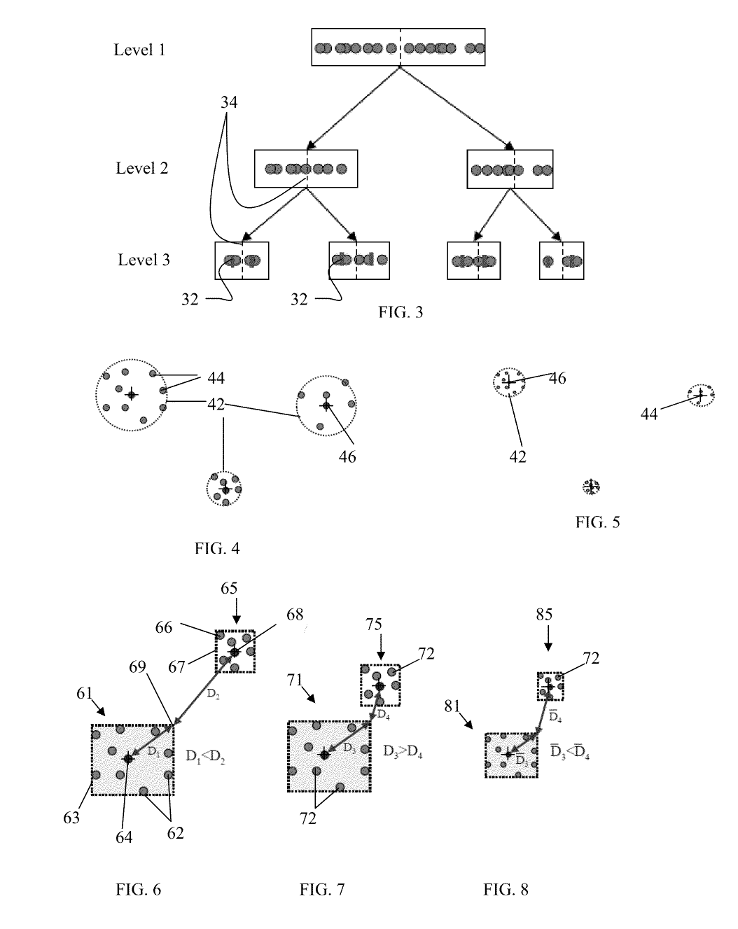

FIG. 3 shows an example of the proposed multi-bit quantization scheme for q=3 bits. Quantizers are depicted with reference 32 at the leaf nodes, and threshold values are represented by dashed lines 34. For the dataset {1,2,3,4,5,6,7,8,9,10}, the method may apply such multi-bit MMSE quantization with q=2 bits. The method may derive the hierarchical binary tree by considering at level 1 a data comprised of the whole data, e.g. dataset {1,2,3,4,5,6,7,8,9,10}. The method may then compute the mean (5.5 with the numeric values of the example). At a level 2 of the tree hierarchy, the method may divide the first datasets into two datasets using the mean as a threshold, e.g. {1,2,3,4,5} and {6,7,8,9,10} in the case of the example. The means of the datasets are determined (3 and 9). At a final level, i.e. level 2, the method may perform 1-bit MMSE quantization on each dataset, so as to obtain datasets {1,2}, {3,4,5}, {6,7}, and {8,9,10} and means 1.5, 4, 6.5 and 9. The method of the example thus quantizes the initial dataset {1,2,3,4,5,6,7,8,9,10} to {1.5,1.5,4,4,4,6.5,6.5,9,9,9}. An advantage of this scheme is simplicity and efficiency of implementation.

The method may optionally perform an efficient bit allocation algorithm in order to maintain high reconstruction accuracy given storage constraints. The method may thus include a mix between 1-bit MMSE quantization and multi-bit MMSE quantization depending on the clusters. The compression scheme may specifically comprise, for each cluster, the determination of an optimal number of bits allocated for the cluster. The optimal number of bits allocated for a cluster is the number obtained by solving a global optimization problem under the constraint of a total storage space. This could amount to solving the following optimization problem

$${min}_{{B}_{1} , … , {B}_{K}} \frac{1}{N} {\sum }_{k = 1}^{K} {N}_{k} {MSE}_{k} ( {B}_{k} )$$

$$s . t . {\sum }_{k = 1}^{K} ( {TB}_{k} {N}_{k} + BT {2}^{{B}_{k}} ) \leq \overline{B}$$

wherein indices k represent the clusters and K the total number of clusters, B the number of bits used to represent the original data, Bₖ the number of allocated bits for a cluster k, MSEₖ(Bₖ) the mean square error using a Bₖ-bit quantization on cluster k, B̅ the total budget of bits that can be used to perform quantization, N the total number of pieces of data and Nₖ the number of pieces of data of cluster k, and T the number of dimensions.

To tackle this problem efficiently, the method may e.g. implement the following greedy algorithm:

Greedy algorithm for multi-bit allocation

| $Inputs \text{:} {\{ {\{ {MSE}_{k} ( {B}_{k} ) \}}_{{B}_{k} = 1}^{{U}_{k}} \}}_{k = 1}^{K}$ $Outputs \text{:} {\{ {B}_{k} \}}_{k = 1}^{K} , MSE := \frac{1}{N} {\sum }_{k = 1}^{K} {N}_{k} {MSE}_{k} ( {B}_{k} )$ | | |
|---|---|---|
| | 1) | For each cluster 1 ≦ k ≦ K, define the relative |
| | | MSE improvement attained when using q instead |
| | | of q − 1 bits (q = 2, . . . , Uₖ) by Iₖ(q) = |
| | | MSEₖ(q) − MSEₖ(q − 1) |
| | 2) | Set Bₖ ← 1 for all k, and set the unused budget: |
| | | R ← B̅ − NT − 2BTK |
| | 3) | If R ≦ 0 return {Bₖ}_{k =} ₁^{K} and MSE |
| | 4) | else define K = {1, . . . , K} |
| | 5) | Let k* = argmin_{kεK}NₖIₖ(Bₖ + 1) |
| | 6) | If R − TN_{k*} − BT2^{B}^{_{k*}} > 0 |
| | | B_{k*} ← B_{k*} + 1; |
| | | R ← R − TN_{k*} − BT2^{B}^{_{k*}}; |
| | | go to step 3; |
| | 7) | else set K ← K\k* |
| | 8) | If K == return {Bₖ}_{k = 1}^{K} and MSE |
| | 9) | else go to step 5 |
| | 10) | endif |
| | 11) | endif |
| | 12) | endif |

wherein Uₖ:=min{Bₖ:T(Bₖ−1)Nₖ+BT2^{B}^{ₖ}⁻¹≦ B̅−TN−2BTK} is an upper bound on the number of bits allocated to cluster k based on the total budget B̅.

In the example of FIG. 1, rescaling (S21, S22) the data by moving the pieces of data towards the centroid of their cluster comprises determining (S21) a key (α) that is a number in the interval (0, 1) and moving (S22) each piece of data by an affine transformation having the centroid of the cluster of the piece of data as origin and the key (α) as factor.

The step of moving (S22) is now discussed. Given a cluster partition {Sₖ}ₖ₌₁^{K} with corresponding centroids {cₖ}ₖ₌₁^{K}, the moving (S22) transforms the original data {xᵢ}ᵢ₌₁^{N}, according to an affine transformation, i.e., so that if xᵢ belongs to cluster Sₖ it is transformed to x̅ᵢ by means of x̅ᵢ=cₖ+α(xᵢ−cₖ). For a given cluster, this transformation is an affine contraction, i.e., it reduces the distance between two points in the same cluster, as well as the distance between a given point and the centroid of the cluster it belongs to, by a factor of α, where α is a number in the interval (0,1). This is illustrated in FIGS. 4 and 5 which respectively represent clusters 42 with pieces of data 44 (which are quantized as the quantization has already occurred in this example) and centroids 46 before and after the affine transformation of the step of moving (S22). After the affine transformation, the centroids 46 are preserved and the pieces of data 44 are moved towards the centroids 46. Clusters 42 are thus contracted.

The proposed method can be considered as an encoding-decoding procedure: first, a user (encoder) may cluster the original dataset using K-means. Given the calculated cluster partition {Sₖ}ₖ₌₁^{K}, the method may quantize the data using MMSE quantizers per cluster and dimension. After that, the method may select (S21) a number αε(0,1) which can be considered as a coding key, and transform the quantized data via the affine transformation of the step of moving (S22). The transformed and quantized dataset may be stored and e.g. can be transmitted to another user (decoder). If the other user runs K-means clustering on the transmitted compressed data, the result is the same as performing K-means clustering on the original dataset. While the clustering outcome is maintained, the distortion due to applying the data transformation described above might be significant. This makes the method of interest for data hiding applications. To retrieve the quantized version of the original dataset, the user (decoder) may have been provided with the key α. This is possible in the case of the example, since the method of the FIG. 1 example comprises the storing (S30) of the key α, e.g. for later transmittal.

Thus, the rescaling step of the decompression method may include moving the data according to an affine transformation for each cluster resulting from a K-means clustering of the compressed data. The affine transformation for a respective cluster may have the centroid of the respective cluster as origin and the inverse of the key (1/α) as factor. The clustering structure (i.e. positions of centroids and assignments of the compressed pieces of data to the centroids) may be provided or alternatively, retrieved by performing a K-means clustering (with the same value of K as in the compression method, which value may be stored) on the compressed data.

The step of determining (S21) the key is now discussed. It can be shown that a small enough value of αε(0,1) is guaranteed to preserve K-means clustering after quantization. The question of practical interest is two-fold: a) is it necessary to perform the transformation and, b) if so, how small should α be? The answer lies in how well clusters are “separated” from one another. It turns out that the method can provide guarantees on preserving the optimal K-means clustering structure when the optimal assignment has the “separation property” (i.e., clusters are “well-separated”).

For a given cluster (say S with corresponding centroid c_{S}) of quantized data (i.e., the group consisting of the quantized form of pieces of data belonging to a same K-means cluster), let us consider the minimal box (i.e., hyper-rectangle) which contains all data points of the cluster (say Bₛ). Then, for any other cluster S′ the distance of its corresponding centroid c_{S′} from the closest point in the box B_{S} (say point x_{S,S′}) has to be greater than the distance between x_{S,S′} and c_{S}. This has to hold for all clusters. Thus, calculating a such that the property holds may require O(K²N) computations. Thus, determining (S21) the key may comprise determining for each cluster (after the cluster has undergone quantization) the minimal box that contains all pieces of data of the cluster and determining, as the key, the largest number of interval (0, 1) for which, for the box of each cluster, for each other cluster (i.e., a double “for” loop may thus be implemented), the distance between the centroid of the other cluster and the point of the box which is the closest to said centroid of the other cluster is (strictly) larger than the distance between the centroid of the box and said point.

FIG. 6 shows an example of two clusters 61 and 65 that are well-separated. Indeed, as can be seen on FIG. 6, the minimal boxes 63 and 67 of clusters 61 and 65 were respectively determined as the smallest hyper-rectangles which contain respectively all quantized pieces of data 62 of cluster 61 and all quantized pieces of data 66 of cluster 65. As can be seen, the distance D₂ between the centroid 68 of cluster 65 and the point of the box 63 which is the closest to centroid 68, i.e., point 69, is strictly larger than the distance D₁ between the centroid 64 of the box 63 (i.e., the centroid 64 of cluster 61) and point 69. Similarly, although not represented, the distance between centroid 64 and the point of box 67 which is the closest to said centroid 64 is strictly larger than the distance between the centroid 68 and said point.

On the contrary, FIG. 7 shows an example of two clusters 71 and 75, of quantized pieces of data 72 that have undergone the applying (S10), that are not well-separated as D₃ is larger than D₄, when the contrary should have held for well-separation. FIG. 8 illustrates how the moving (S22) re-establishes the well-separation property, as the moved clusters 81 and 85 are well separated. Thus, performing the K-means clustering on the pieces of data 72 of FIG. 8 would lead to the same clustering structure. In other words, clusters 81 and 85 (that are clusters resulting from K-means clustering on the original data) would be retrieved if the same K-means clustering was performed on the quantized data.

Another way of selecting (S21) a to guarantee preservation of global optimality of the K-means assignment comprises two steps. First, for each given cluster S, the method may calculate the ratio of the smallest distance between any two distinct sample points in S to the cluster “extent,” as quantified by the largest distance between two points in the smallest box containing it. Then, the method may select (S21) α as the minimum of such computed ratios. This has worst-case complexity O(N²K) but can provide strong theoretical guarantees.

The method was tested and the results are discussed below. For the experiments, the inventors have utilized data from publicly available stock market time series corresponding to 2169 stock symbols from companies listed on NASDAQ, reporting the stock values for a period of 1000 days, i.e., approximately 3 years. Therefore, referring to the notations used above, T=1000 and N=2169. The inventors have compared 1-bit MMSE quantization vs. the 1-bit Moment Preserving Quantization (MPQ) discussed earlier (presented by D. Turaga, M. Vlachos, and O. Verscheure entitled “On K-Means Cluster Preservation Using Quantization Schemes”, in IEEE International Conference on Data Mining (ICDM), pages 533-542, 2009). It was shown that both quantization schemes depict excellent cluster preservation when Lloyd's algorithm is used with the K-means++ centroid initialization scheme, but MMSE quantization leads to lower distortion.

The inventors have also experimentally verified that the proposed rescaling (S21, S22) transformation indeed preserves the clustering outcome in all instances. It was shown that using multi-bit MMSE quantization has the benefit of significantly reducing object distortion while accurately preserving the clustering outcome. The inventors have used K-means++ with K=3,5,8 clusters which performed very well in all experiments.

After obtaining the clustering assignment via K-means++, the inventors have used it to quantize the time series using separate 1-bit MMSE quantizers (one per cluster and dimension). The inventors have also used MPQ quantizers in order to compare, as well as multi-bit MMSE quantizers with q=2, 4 bits. The inventors have then performed clustering using K-means++ on the quantized dataset, and compared the resulting cluster centroids and cluster assignments before and after quantization.

Table I shows the fraction of quantized points pertaining to the same clusters as before quantization for a) MPQ, b) q-bit MMSE for q=1, 2, 4 denoted by MMSE(q), as well as the quantized version of the transformed dataset, denoted using “_t” after the name of quantization. We note that the quality of cluster preservation is excellent: more than 98% of the samples belong in the same clusters before and after quantization, while the transformation always yields perfect cluster preservation. α_{crit} is the key as determined in step (S21).

TABLE I
Cluster preservation after quantization and data transformation

| K | MPQ | MMSE(1) | MMSE(2) | MMSE(4) | α_{crit} | MPQ_t | MMSE_t(1) | MMSE_t(2) | MMSE_t(4) |
|---|---|---|---|---|---|---|---|---|---|
| 3 | 1 | 1 | 0.991 | 0.990 | 0.505 | 1 | 1 | 1 | 1 |
| 5 | 1 | 1 | 0.994 | 0.994 | 0.503 | 1 | 1 | 1 | 1 |
| 8 | 0.999 | 1 | 0.980 | 0.988 | 0.098 | 1 | 1 | 1 | 1 |

The inventors have also studied the distortion induced on the original data by the proposed quantization schemes. The inventors have recorded the normalized Mean Square Error per dimension (MSE/T). The results are summarized in Table II. It is evident that using 1-bit MMSE quantization incurs significantly less distortion compared to MPQ, 37% less MSE on average in all cases. Using multi-bit quantization further reduces the MSE substantially over 1-bit MPQ, 70%, 96%, on average, for q=2 and q=4 bits, respectively. Furthermore, the MSE is decreased by increasing the number of clusters: 76% using K=5 and 84% using K=8 over K=3. This is because the contemplated quantization schemes are cluster-centric, whence increasing K increases the number of quantizers, while decreasing the number of datapoints to be jointly quantized (those that belong in the same cluster).

TABLE II
MSE due to quantization

| K | MPQ | MMSE(1) | MMSE(2) | MMSE(4) |
|---|---|---|---|---|
| 3 | 131.4 | 89.3 | 57.1 | 9.6 |
| 5 | 45.3 | 27.3 | 10.0 | 1.2 |
| 8 | 29.5 | 18.1 | 7.0 | 0.7 |

FIG. 9 shows one visual example of how multi-bit quantization reduces the data distortion. FIG. 9 depicts a sample time series for the stock dataset along with its quantized version using 1-bit and 4-bit MMSE, as well as the absolute error due to quantization. On the left side is shown the quantized time series using 1-bit MMSE. On the right side is depicted the quantized time series using 4-bit MMSE. The bottom portion captures the absolute quantization error

Increasing the number of bits to represent each quantized datapoint and also increasing the number of clusters helps to better preserve the shape of the time series while maintaining excellent cluster preservation performance. This, however, comes at the expense of increased storage requirements. This can be quantified by calculating the compression ratio:

$$ρ = \frac{qTN + {2}^{q} BTK}{BTN}$$

wherein q bits are used for each cluster and dimension.

Table III presents the compression ratio for all cases, by assuming that the original (non-quantized) data are represented using B=8 bits. As it can be seen from the table, the compression can result in a storage reduction of almost a factor of 8. The compression ratio varies with the number of clusters and bits, deteriorating as K and q increase.

TABLE 3
Compression efficiency

| # of clusters | # of bits (q) | Compression (ρ) |
|---|---|---|
| K = 3 | 1 | 0.128 |
| | 2 | 0.256 |
| | 4 | 0.522 |
| K = 5 | 1 | 0.13 |
| | 2 | 0.259 |
| | 4 | 0.537 |
| K = 8 | 1 | 0.132 |
| | 2 | 0.265 |
| | 4 | 0.559 |

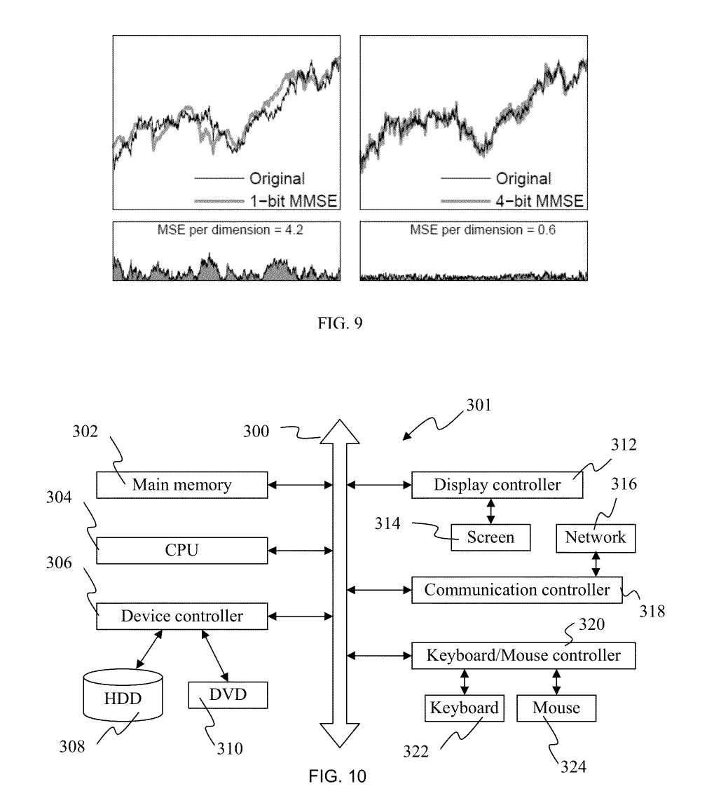

FIG. 10 is a block diagram of computer hardware according to an embodiment of the invention, suitable for performing the compression and/or decompression methods, for example if instructions for performing such methods are recorded on a memory. A computer system (301) according to an embodiment of the invention includes a CPU (304) and a main memory (302), which are connected to a bus (300). The bus (300) is connected to a display controller (312) which is connected to a display (314) such as an LCD monitor. The display (314) is used to display information about a computer system. The bus (300) is also connected to a storage device such as hard disk (308) or DVD (310) through a device controller (306) such as an IDE or SATA controller. The bus (300) is further connected to a keyboard (322) and a mouse (324) through a keyboard/mouse controller (310) or a USB controller (not shown). The bus is also connected to a communication controller (318) conforms to, for example, an Ethernet (registered trademark) protocol. The communication controller (318) is used to physically connect the computer system (301) with a network (316).

The invention initiates a formal and rigorous study for determining when the outcome of K-means clustering is preserved by compression/data-simplification methods. It was shown both analytically and experimentally, that using 1-bit Minimum Mean Square Error (MMSE) quantizers, per dimension and cluster, is sufficient to preserve the clustering outcome, provided that the clusters are ‘well-separated’. When this is not the case, the method devises a data transformation which can always assure preservation of the clustering outcome. Moreover, were also considered multi-bit quantization schemes that provide even better balance between data compression and data reconstruction, while also ensuring cluster preservation. A efficient greedy algorithm for bit allocation was provided that minimizes the mean squared compression error given storage constraints.

This work goes well beyond data-mining by providing a rigorous formulation and analysis. It is proposed using Minimum Mean Square Error-based quantization schemes in conjunction with an invertible data transformation. The inventors have established theoretical guarantees on 100% cluster preservation for all instances, which is also verified in experiments. In addition, this work uses multi-bit quantization to support a fine-grained trade-off between compression efficiency and the data reconstruction, while further enabling data privacy functionality.

1. A computer-implemented method for compressing data, wherein the data are partitioned into clusters of pieces of data, resulting from a K-means clustering of the data, each cluster having a centroid, the method comprising:
applying a compression scheme to data that preserves a centroid of each respective cluster and reduces variance of each cluster; and
rescaling the data by moving pieces of data towards the centroid of the respective cluster.

2. The method of claim 1, wherein the rescaling comprises determining a key (α) that is a number in interval (0, 1) and moving each piece of data by an affine transformation having the centroid of the cluster of the piece of data as origin and the key (α) as factor.

3. The method of claim 2, wherein determining a key comprises determining for each cluster a minimal box that contains all pieces of data of the cluster and determining, as the key, a largest number in the interval (0, 1) for which, for the box of each cluster, for each other cluster, a distance between the centroid of the other cluster and a point of the box which is closest to said centroid of said other cluster is larger than a distance between the centroid of the cluster of the box and said point.

4. The method of claim 2, wherein the method further comprises storing the key.

5. The method of claim 1, wherein the compression scheme is, for each cluster, a quantization performed on the cluster.

6. The method of claim 5, wherein the compression scheme is a MMSE (Minimum Mean Square Error) quantization.

7. The method of claim 6, wherein the compression scheme is a multi-bit MMSE quantization.

8. The method of claim 7, wherein the compression scheme comprises, for each cluster, a determination of an optimal number of bits allocated for the cluster.

9. The method of claim 1, wherein the method further comprises, prior to the applying and the rescaling, performing K-means clustering of the data using one of Lloyd's algorithm and a Kmeans++ algorithm.

10. A computer-implemented method for decompressing data, wherein data is partitioned into clusters of pieces of data, resulting from a K-means clustering of the data, each cluster having a centroid, the method comprising:
rescaling data by moving pieces of data away from a centroid of the respective cluster.

11. A computer readable storage medium having recorded thereon a computer program for compressing data, wherein the data are partitioned into clusters of pieces of data, resulting from a K-means clustering of the data, each cluster having a centroid, the method comprising:
applying a compression scheme to data that preserves a centroid of each respective cluster and reduces variance of each cluster; and
rescaling the data by moving pieces of data towards the centroid of the respective cluster.
